(19) United States
(12) Patent Application Publication
(10) Pub. No.: US 2014/0358510 A1
(43) Pub. Date: Dec. 4, 2014

(54) SYSTEM AND METHOD FOR CHARACTERIZING UNCERTAINTY IN SUBTERRANEAN RESERVOIR FRACTURE NETWORKS

(71) Applicants: Sudipta Sarkar, Katy, TX (US); Adwait Chawathe, Sugarland, TX (US)

(72) Inventors: Sudipta Sarkar, Katy, TX (US); Adwait Chawathe, Sugarland, TX (US)

(73) Assignee: CHEVRON U.S.A. INC., San Ramon, CA (US)

(21) Appl. No.: 13/904,180

(22) Filed: May 29, 2013

(51) Int. Cl. E21B 49/00; G06F 17/50

(52) U.S. Cl. CPC E21B 49/003; G06F 17/5009
USPC 703/10

(57) ABSTRACT

A system and method for characterizing uncertainty in a subterranean fracture network by obtaining a natural fracture network, obtaining dynamic data, simulating hydraulic fracturing and microseismic events based on the natural fracture network and the dynamic data, generating a stimulated reservoir volume (SRV), and quantifying the uncertainty in the SRV. It may also include narrowing the uncertainty in the SRV through the use of Design of Experiment methods and characterizing the SRV using static and/or dynamic data.

### FIELD OF THE INVENTION

The present invention relates generally to methods and systems for characterizing fracture networks in subterranean reservoirs and, in particular, methods and systems for characterizing the uncertainty in a stimulated reservoir volume.

### BACKGROUND OF THE INVENTION

One of the challenges for completing wells in unconventional reservoirs such as shales and tight sands is successfully connecting the hydraulically-induced fractures with the natural fracture system, thereby significantly increasing the effective drainage volume, also referred to as the Stimulated Reservoir Volume (SRV). A large SRV infers high production for that well. Unfortunately, identifying and integrating the appropriate static (geological, petrophysical, geophysical, etc.) and dynamic (pumping, production, etc.) datasets and understanding the inherent uncertainty in those datasets makes it difficult to quantify the uncertainty in the SRV (and hence the production potential of a well). Appropriate quantification of the SRV will allow optimization of hydraulic fracturing stages and design, and the number of wells being drilled, resulting in significant cost savings.

Estimates of the SRV rely primarily on microseismic measurements. By locating microseismic events recorded during a hydraulic fracturing job, one can get useful information about the height, growth, size and directionality of the induced hydraulic fracture. Microseismic events may also be used to monitor fracture growth which allows microseismic data to be used to provide approximate estimates of the SRV. Although microseismic measurements are made routinely, industry-standard data gathering and processing of the microseismic data is lacking, resulting in a large uncertainty in quality of the results.

In addition to making actual microseismic measurements, SRV quantification could be done using geomechanical/hydraulic fracturing simulators that predict microseismic response given static and dynamic information. Such simulators are now available in the market but a clear and streamlined workflow does not exist whereby a user can identify and integrate appropriate static and dynamic data along with the measured microseismic data in the simulator to characterize the uncertainty in the SRV. The current art uses ad-hoc procedures which result in a single, poorly defined SRV, and completely ignores the large uncertainty associated with it.

### SUMMARY OF THE INVENTION

Described herein are implementations of various approaches for a computer-implemented method for characterizing uncertainty in a subsurface region of interest.

A computer-implemented method for characterizing uncertainty in a subsurface region of interest is disclosed. The method includes obtaining a natural fracture network, obtaining dynamic data, simulating hydraulic fracturing and microseismic events based on the natural fracture network and the dynamic data, generating a stimulated reservoir volume, and quantifying the uncertainty in the SRV. The method may also include estimating the uncertainty in the SRV through the use of Design of Experiment methods and characterizing the SRV. The characterization may be done using static and/or dynamic data.

In another embodiment, a computer system including a data source or storage device, at least one computer processor and a user interface used to implement the method for characterizing uncertainty in a subsurface region of interest is disclosed.

In yet another embodiment, a non-transitory processor-readable medium having computer readable code on it, the computer readable code being configured to implement a method for characterizing uncertainty in a subsurface region of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 is an illustration of an embodiment of the present invention;

FIG. 3 is a demonstration of a step of an embodiment of the present invention;

FIG. 4 is a demonstration of a step of an embodiment of the present invention;

FIG. 5 is a demonstration of a step of an embodiment of the present invention; and

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, non-transitory processor readable medium for use with a computer processor, such as a CD, pre-recorded disk or other equivalent devices, may include a program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

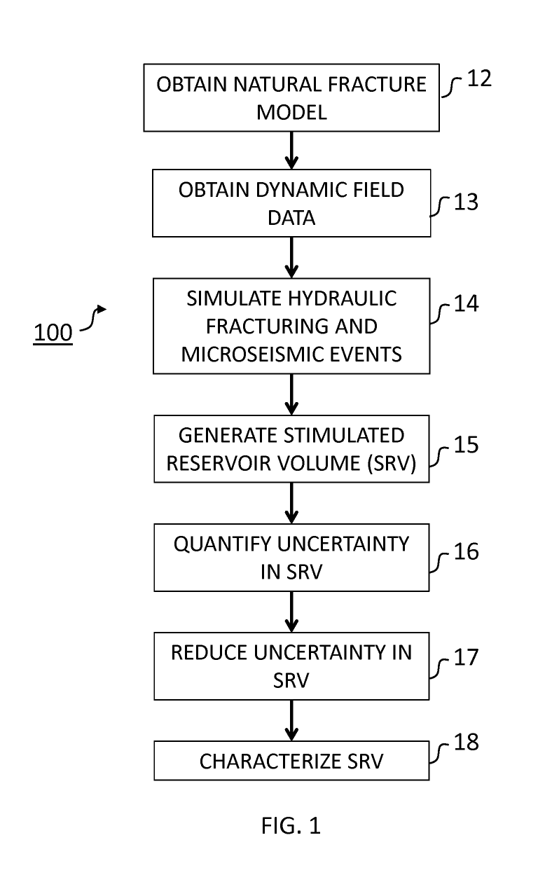

The present invention relates to characterizing uncertainty in a subterranean region of interest. One embodiment of the present invention is shown as method 100 in FIG. 1. At operation 12, a natural fracture model of the subterranean region of interest is obtained. This natural fracture model may be based, for example, on knowledge of local or analog geology, stress information, well logs, seismic data, and/or core data. These examples are not meant to be limiting. One skilled in the art will appreciate that there are a number of possible ways to obtain the natural fracture model. The natural fracture model may have been generated prior to operation 12 and simply supplied to the method at operation 12. It may also be generated as part of operation 12.

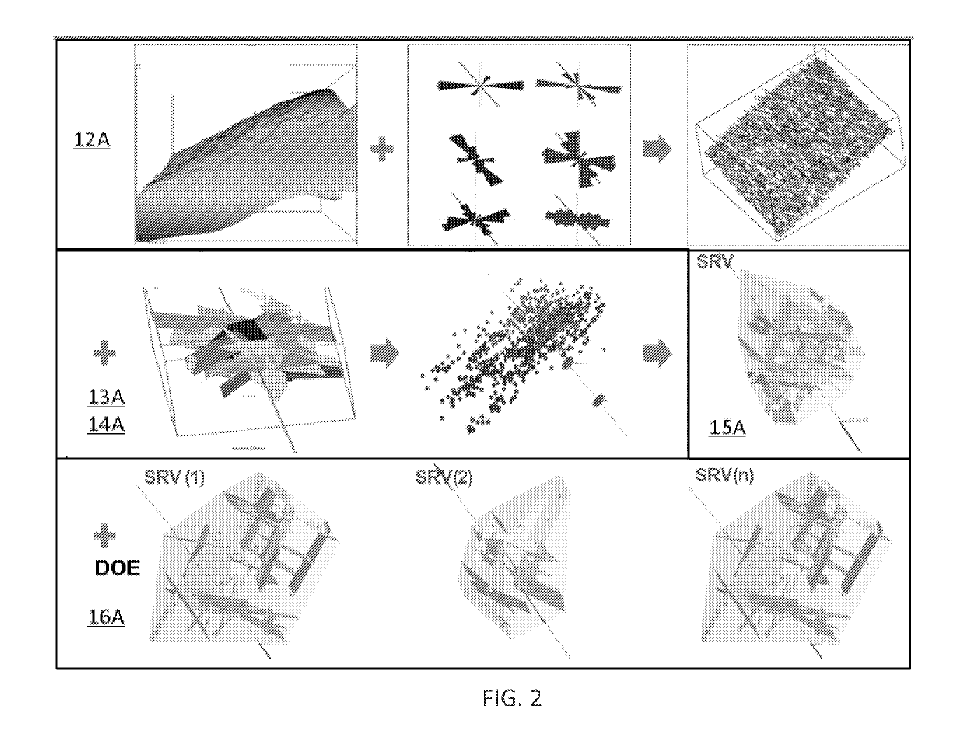

If the natural fracture model is generated at operation 12, it may be created using a software package such as FracMan or Fraca, or other methods known to those skilled in the art. In one embodiment, the natural fracture framework might be generated from geology, well logs, seismic data, and/or core data using the Discrete Fracture Network (DFN) technique. The natural fracture model may also be based on stress data and rock property data which may be included in the natural fracture network. The stress data and rock property data may be determined from core data and well logs, particularly including data on breakouts. This allows the natural fracture model to include a representation of the geomechanics of the subterranean region of interest. This is demonstrated in FIG. 2 in panel 12A.

Referring again to FIG. 1, at operation 13 dynamic field data may be obtained. This dynamic field data may include, for example, fluid flow data, injection pressure, injection volume, and/or injection duration, including pumping pressure and rate. The dynamic field data may be data that was actually used in a field or be parameters input by the user as a simulation of dynamic field data. This is demonstrated in FIG. 2 in panel 13A.

The natural fracture model and dynamic field data may be used together at operation 14 to create multi-stage hydraulic fractures and simulate microseismic events generated by the hydraulic fracturing. The microseismic events may occur due to fracture activation or reactivation. This is demonstrated in FIG. 2 in panel 14A.

Once the microseismic events have been simulated, the stimulated reservoir volume (SRV) is generated at operation 15. The SRV may be determined, for example, by putting a wrapper around the microseismic events. One skilled in the art will appreciate that there are many ways to generate the SRV. For example, a Convex Hull approach may be used, which often finds an upper-bound estimate of the SRV. Alternatively, a fracture slab approach can yield a lower-bound estimate of the SRV. These examples are not meant to be limiting; any method for defining the SRV based on the simulated microseismic events may be used. This is demonstrated in FIG. 2 in panel 15A.

The SRV generated at operation 15 has a high degree of uncertainty depending on the uncertainty of the input data for the natural fracture model and the simulation of the hydraulic fracturing and microseismic events. The uncertainty in the input data may arise from, for example, poor data quality, insufficient quantity of data, poor modeling of the subsurface, poor modeling of the hydraulic fractures, and/or poor simulation of the microseismic events. The uncertainty in the SRV makes it risky for use in estimating potential production volumes, determining optimum hydraulic fracturing plans, and/or determining locations and number of wells to be drilled.

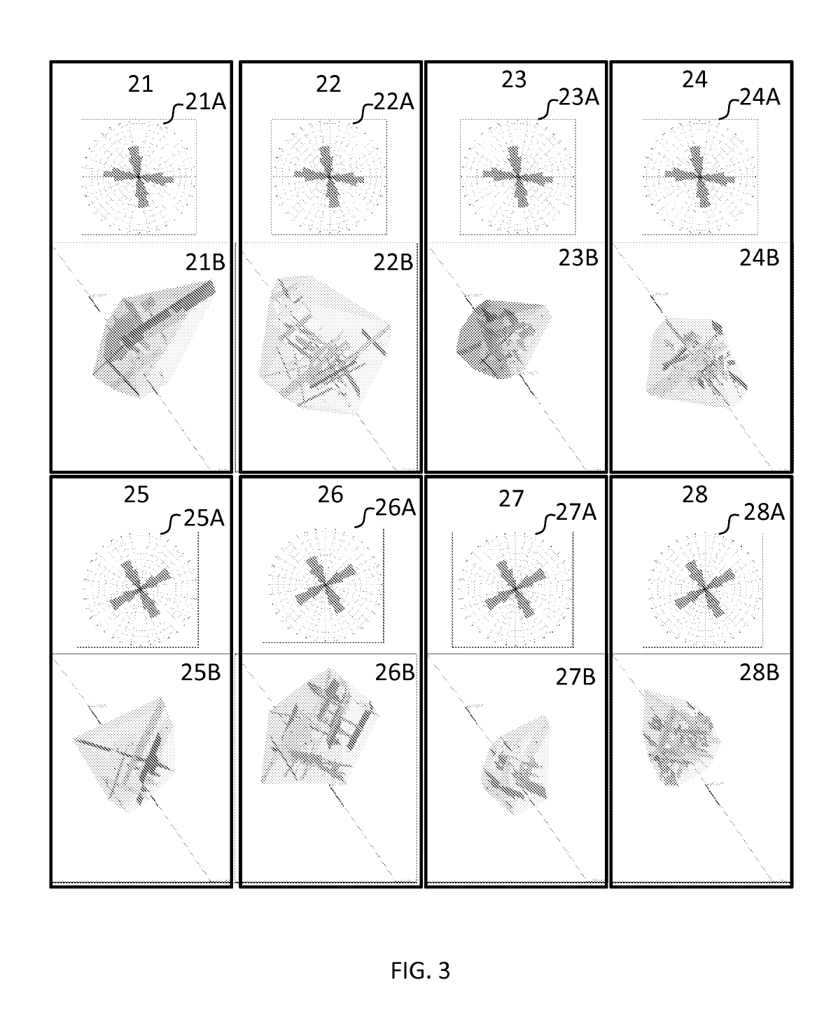

Referring again to FIG. 1, at operation 16 the uncertainty in the SRV is quantified. This may be accomplished, for example, by using Design of Experiments (DOE), also called Experimental Design. This process methodically varies one or more parameters to identify the parameters that have the largest impact on the result and, therefore, the greatest influence on the uncertainty. This is demonstrated, for example, in FIG. 2 as panel 16A and in FIG. 3. In FIG. 3, the input parameters for the natural fracture network are being tested. In particular, the natural fracture orientation, natural fracture intensity, and natural fracture size are being changed. Panel 21 shows the orientation 21A of the fractures, which in this example have an intensity of P32˜0.01 and a mean size of 50 ft resulting in the SRV 21B of 1.3×10⁷ ft³; Panel 22 shows the orientation 22A, having an intensity of P32˜0.01 and a mean size of 30 ft resulting in the SRV 22B of 1.9×10⁷ ft³; Panel 23 shows the orientation 23A, having an intensity of P32˜0.05 and a mean size of 50 ft resulting in the SRV 23B of 9.2×10⁶ ft³; Panel 24 shows the orientation 24A, having an intensity of P32˜0.05 and a mean size of 30 ft resulting in the SRV 24B of 8.4×10⁶ ft³; Panel 25 shows the orientation 25A, having an intensity of P32˜0.01 and a mean size of 50 ft resulting in the SRV 25B of 1.2×10⁷ ft³; Panel 26 shows the orientation 26A, having an intensity of P32˜0.01 and a mean size of 30 ft resulting in the SRV 26B of 1.6×10⁷ ft³; Panel 27 shows the orientation 27A, having an intensity of P32˜0.05 and a mean size of 50 ft resulting in the SRV 27B of 7.3×10⁶ ft³; and Panel 28 shows the orientation 28A, having an intensity of P32×0.05 and a mean size of 30 ft resulting in the SRV 28B of 9.2×10⁶ ft³.

After the uncertainty in the SRV has been assessed at operation 16, this uncertainty may be narrowed at operation 17. This may be accomplished by techniques that use observed microseismicity to help constrain the SRV. These techniques may include but are not limited to finite-difference modeling and clustering algorithms.

Finite-difference modeling may be used to simulate microseismic waveforms (signals) in the natural fracture model. The modeled microseismic waveforms can be compared with those recorded during the actual microseismic survey, which may help narrow the location uncertainty in the microseismic data. Having more accurate microseismic event locations allows the selection of more plausible outcomes of modeled microseismic and SRVs. Finite-difference modeling would also help with understanding of the rock failure modes and microseismic source mechanisms during hydraulic fracturing, which could be used to further constrain stress and natural fracture inputs when obtaining a natural fracture model, as at operation 12.

Many different clustering algorithms may be used to help narrow the uncertainty. Various techniques exist which may be used to identify distinct clusters or features (e.g. fracture planes, lineation) from the observed microseismic “cloud” data. This may help constrain some of the input parameters required for natural fracture modeling as in operation 12. Clustering algorithms would include statistical techniques such as collapsing, centroid determination, and other techniques such as waveform cross-correlation, multiplet analysis, joint-hypocenter determination and double-difference location methods. Any algorithm used to analyze the observed microseismic cloud in order to better constrain the natural fracture model may be used.

It is also possible to further constrain the characterization of SRV by including production or flow data in the Design of Experiment process. Production or flow profiles may be estimated using an appropriate reservoir flow simulator, which may then be compared with observed production data or flow profiles derived from techniques such as well testing, PLT (Production Logging Tool), DTS (Distributed Temperature Sensing), etc even on a hydraulic fracture stage level if such data is available. Such comparison will further narrow down the range of possible SRVs by constraining the model parameters, thereby closing the loop using both static (microseismic-based) and dynamic (flow-based) characterization. At the end, the workflow will help evaluate the efficacy of the completions or hydraulic fracturing program.

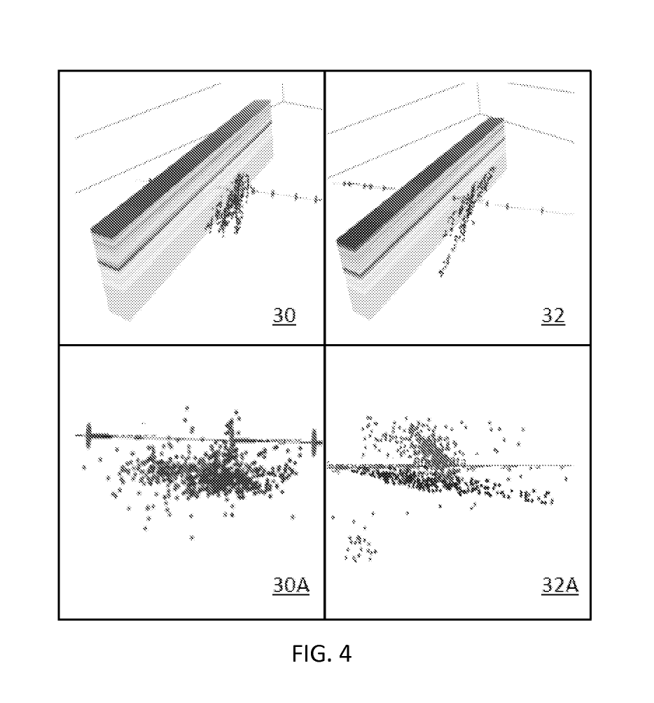

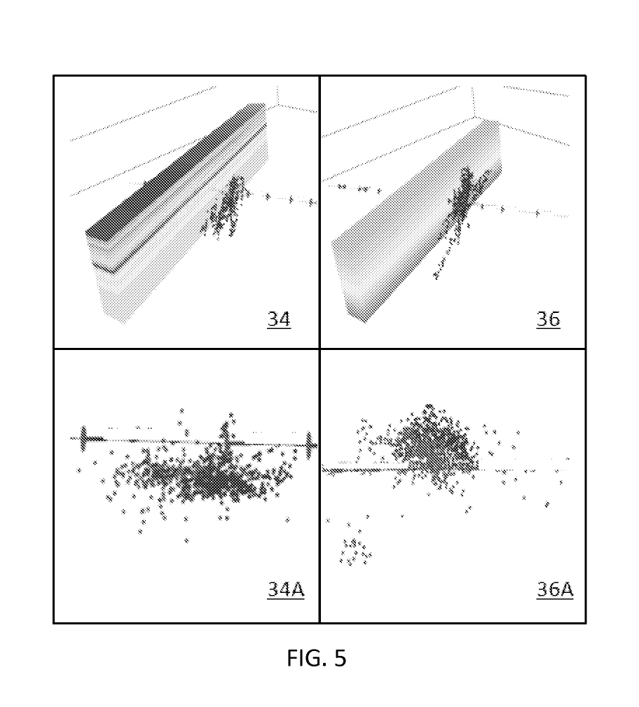

After the SRV has been refined at operation 17, it can be characterized based on observations of the improved SRV against static and dynamic data at operation 18. This is demonstrated in FIGS. 4 and 5. In these figures, the potential SRVs are shown in panels 30, 32, 34, and 36 for different stages of the hydraulic fracturing along with the modeled microseismic data from operation 14 in FIG. 1. The modeled microseismic data is shown as dark gray dots. This is compared with the observed microseismic data which is light gray dots. The microseismic data is also shown in panels 30A, 32A, 34A, and 36A. Panels 30 and 34 and panels 30A and 34A are identical; panels 36 and 36A match the observed microseismic better than panels 34 and 34A. This is a static characterization of the SRVs.

Although the foregoing description and FIG. 1 put forth the operations in a linear manner, one skilled in the art will appreciate that many of the operations may be performed concurrently or in a different order. Moreover, it is to be understood that it is possible to repeat operations as more data or results are obtained.

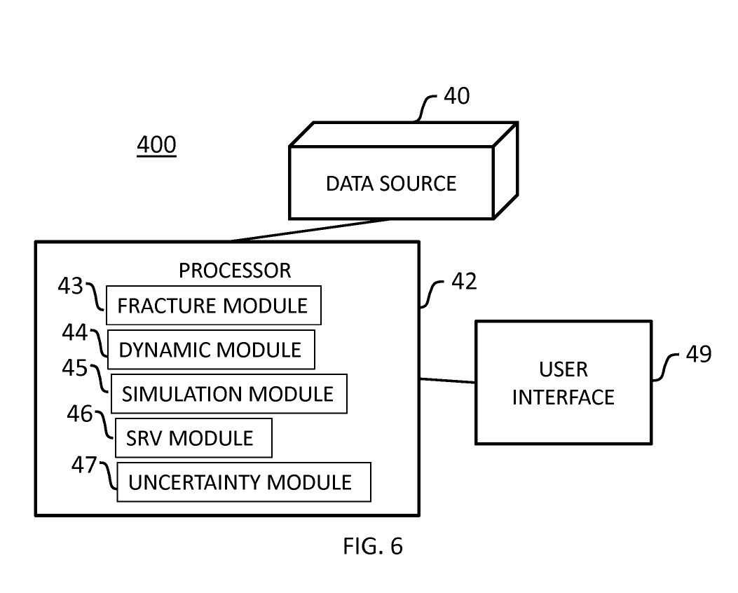

A system 400 for performing the method 100 of FIG. 1 is schematically illustrated in FIG. 6. The system includes a data source/storage device 40 which may include, among others, a data storage device or computer memory. The data source/storage device 40 may contain recorded seismic data, synthetic seismic data, or signal or noise models. The data from data source/storage device 40 may be made available to a processor 42, such as a programmable general purpose computer. Although this diagram shows a single processor, the use of multiple processors, in one machine or in a distributed environment, is also contemplated for the present invention. The processor 42 is configured to execute computer modules that implement method 100. These computer modules may include a fracture module 43 for obtaining a natural fracture model, either from the data source 40 or by creating one as explained previously; a dynamic module 44 for obtaining dynamic field data; a simulation module 45 for creating hydraulic fractures based on the natural fracture model and dynamic field data and simulating microseismic events; an SRV module 46 for determining a SRV; and an uncertainty module 47 for determining the uncertainty in the SRV. Other modules may be included to implement additional embodiments of the present invention, such as a Design of Experiment module and/or a characterization module. One skilled in the art will appreciate that these modules may be combined in many ways and do not have to be distinct modules; additionally, each module might also be split into two or more parts; any combination of modules that together perform the method of the present invention is within the scope of this system. The system may include interface components such as user interface 49. The user interface 49 may be used both to display data and processed data products and to allow the user to select among options for implementing aspects of the method. By way of example and not limitation, the SRVs computed on the processor 42 may be displayed on the user interface 49, stored on the data storage device or memory 40, or both displayed and stored.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1) A computer-implemented method for characterizing uncertainty in a subsurface region of interest, the method comprising:
a. obtaining, at a computer processor, a natural fracture model of the subsurface region of interest;
b. obtaining, at the computer processor, dynamic field data relating to the subsurface region of interest;
c. simulating, via the computer processor, hydraulic fracturing and microseismic events based on the dynamic field data and the natural fracture model;
d. generating, via the computer processor, a stimulated reservoir volume (SRV) based on the simulated microseismic events; and
e. quantifying, via the computer processor, uncertainty in the SRV.

2) The method of claim 1 further comprising narrowing the uncertainty in the SRV to produce an improved SRV.

3) The method of claim 2 further comprising determining a static characterization of the improved SRV by comparing the improved SRV to observed microseismicity.

4) The method of claim 2 wherein narrowing the uncertainty in the SRV is done by using clustering algorithms.

5) The method of claim 2 wherein narrowing the uncertainty in the SRV is done by finite difference modeling.

6) The method of claim 2 further comprising determining a dynamic characterization of the improved SRV based on dynamic flow data and flow simulation models.

7) The method of claim 1 wherein the obtaining the natural fracture model comprises:
a. creating a natural fracture network based on at least one of geology, well logs, seismic data, and core data;
b. obtaining stress data and rock property data for the subsurface region of interest; and
c. combining the stress data and the rock property data with the natural fracture network to create the natural fracture model.

8) The method of claim 7 wherein the natural fracture model is constrained by at least one of well-test data and production data.

9) The method of claim 1 wherein the quantifying the uncertainty in the SRV comprises using Design of Experiments.

10) A system for characterizing uncertainty in a subsurface region of interest, the system comprising:
a. a data source containing data representative of the subsurface region of interest;
b. a computer processor configured to execute computer modules, the computer modules comprising:
i. a fracture module to obtain a natural fracture model of the subsurface region of interest;
ii. a dynamic module to obtain dynamic field data relating to the subsurface region of interest;
iii. a simulation module to simulate hydraulic fracturing and microseismic events based on the dynamic field data and the natural fracture model;
iv. a SRV module to generate a stimulated reservoir volume (SRV) based on the simulated microseismic events; and
v. an uncertainty module to quantify the uncertainty in the SRV; and
c. a user interface.

11) The system of claim 10 further comprising a Design of Experiments module to narrow the uncertainty in the SRV.

12) The system of claim 11 further comprising a characterization module to characterize the SRV.

13) A non-transitory processor-readable medium having computer readable code on it, the computer readable code being configured to implement a method for characterizing uncertainty in a subsurface region of interest, the method comprising:
a. obtaining, at a computer processor, a natural fracture model of the subsurface region of interest;
b. obtaining, at the computer processor, dynamic field data relating to the subsurface region of interest;
c. simulating, via the computer processor, hydraulic fracturing and microseismic events based on the dynamic field data and the natural fracture model;
d. generating, via the computer processor, a stimulated reservoir volume (SRV) based on the simulated microseismic events; and
e. quantifying, via the computer processor, uncertainty in the SRV.

14) The non-transitory processor-readable medium of claim 13 wherein the method further comprises narrowing the uncertainty in the SRV to produce an improved SRV.

15) The non-transitory processor-readable medium of claim 14 wherein the method further comprises determining a static characterization of the improved SRV by comparing the improved SRV to observed microseismicity.
